(19) United States
(12) Patent Application Publication
(10) Pub. No.: US 2019/0180579 A1
(43) Pub. Date: Jun. 13, 2019

(54) SMART HAZARD DETECTION AND ALARM ENCLOSURE

(71) Applicant: Thomas Peter Nuzzo, San Francisco, CA (US)

(72) Inventor: Thomas Peter Nuzzo, San Francisco, CA (US)

(21) Appl. No.: 15/834,498

(22) Filed: Dec. 7, 2017

(51) Int. Cl. G08B 7/06; H04N 7/18; A62C 13/78

(52) U.S. Cl. CPC G08B 7/06; H04N 7/188; G08B 17/10; A62C 13/78; H04N 7/183

(57) ABSTRACT

An enclosure having a body, a light source disposed in the body, and a control system coupled to the light source, the control system including a hazard detector and a controller, the controller operable to provide power to the light source upon receiving a signal from the hazard detector indicating a hazardous condition in the ambient environment.

### CROSS-REFERENCE TO RELATED APPLICATIONS

Not applicable.

### BACKGROUND

### 1. Field

This patent specification relates to devices and apparatuses for hazard detection and remediation. More particularly, this specification relates to a hazard detection and alarm enclosure with communication capability.

### 2. Description of the Related Art

Conventional hazard detection and remediation devices such as fire extinguisher enclosures include an enclosure having a front glass plate that makes visible a fire extinguisher stored inside the enclosure. Hazard detectors such as smoke detectors use sensors to detect substances in the air that may indicate a hazardous condition, such as fire, and typically have an alarm to alert a user in it's proximity. In the case of fire, the visibility of the user is typically reduced by the smoke in the environment making finding the fire extinguisher enclosure difficult.

### SUMMARY

With reference to various embodiments, enclosures are described that facilitate the location of the enclosure by a user in hazardous conditions. In one embodiment, the enclosure has a hazard detector and an LED array disposed in the enclosure. The LED array may be activated when the hazard detector detects a hazardous condition to thereby illuminate the enclosure.

In another embodiment, the enclosure has a controller with communication capabilities to provide information such as the condition of the enclosure and the ambient environment to a local control server, a remote Web application server, or a wireless electronic device such as a smartphone, smart watch, tablet or personal computer.

### BRIEF DESCRIPTION OF THE DRAWING FIGURES

FIG. 1 illustrates an embodiment of a hazard detection and alarm enclosure.

FIG. 2 illustrates an embodiment of a rear wall of the enclosure.

FIG. 3 illustrates an embodiment of an LED array.

FIG. 4 illustrates an embodiment in exploded view.

FIG. 5 illustrates an embodiment of a control system.

FIG. 6 illustrates an embodiment of a controller.

FIG. 7 illustrates another embodiment of a hazard detection and alarm enclosure.

### DETAILED DESCRIPTION

A hazard detection and alarm enclosure may function to provide illumination based upon certain conditions being present in the ambient environment. For instance, when a hazardous condition is detected in the ambient environment by a hazard detector disposed in the enclosure, a light source may illuminate the interior and exterior portions of enclosure making it easier for the occupant to find the enclosure. Under such conditions, an audible alarm may also be activated to further alert the occupant of the hazardous condition.

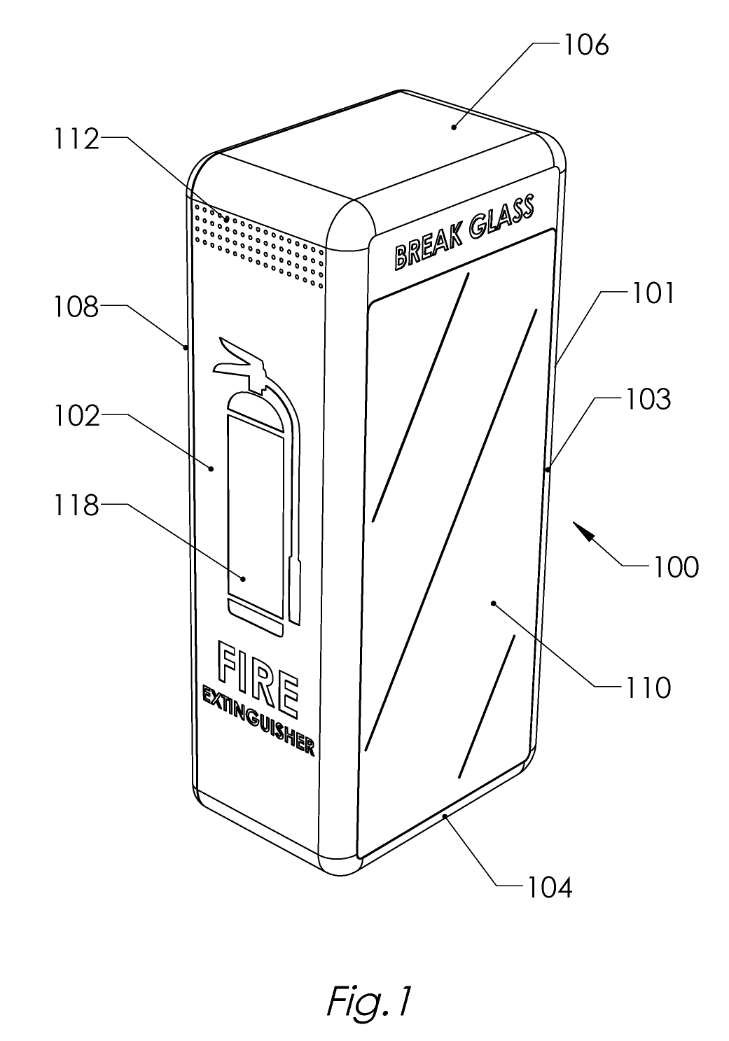

FIG. 1 illustrates an embodiment of the hazard detection and alarm enclosure 100. The enclosure 100 may have a body 101 formed by side panels 102 and 103, a bottom panel 104, a top panel 106, a back panel 108, and a front panel 110. The side panels 102 and 103 may have a plurality of apertures 112 formed therethrough to provide ambient air to the interior of the enclosure 100. The front panel 110 may be transparent. The body 101 may be sized and configured to receive a fire extinguisher (not shown) therein.

The body 101 may have a generally rectangular cross-section and the panels 102, 103, 104, 106, 108 and 110 may be formed of any of a number of materials including non-light-transmissive materials such as sheet metal, and light-transmissive materials such as translucent and transparent materials. The material may comprise a fire-proof material. The panels 102, 103, 104, 106, 108 and 110 may be formed by a process including injection molding, reaction injection molding, casting, vacuum forming, thermal forming, extrusion, CNC machining and manual machining.

A graphical representation 118 disposed on the side panel 102 may include a representation of a fire extinguisher. The graphical representation 118 may be formed as by etching or molding the representation on a light transmissive material forming the side panel 102. Such a graphical representation 118 may transmit light differentially to accentuate the graphical representation 118 when illuminated by a light source. The graphical representation 118 may include a sticker or label affixed to the side panel 102 and a graphical representation printed on the side panel 102. Additional graphical representations such as “FIRE EXTINGUISHER” and “BREAK GLASS” may be disposed on the side panel 102 as well as on the side panel 103 (not shown) and the top panel 106.

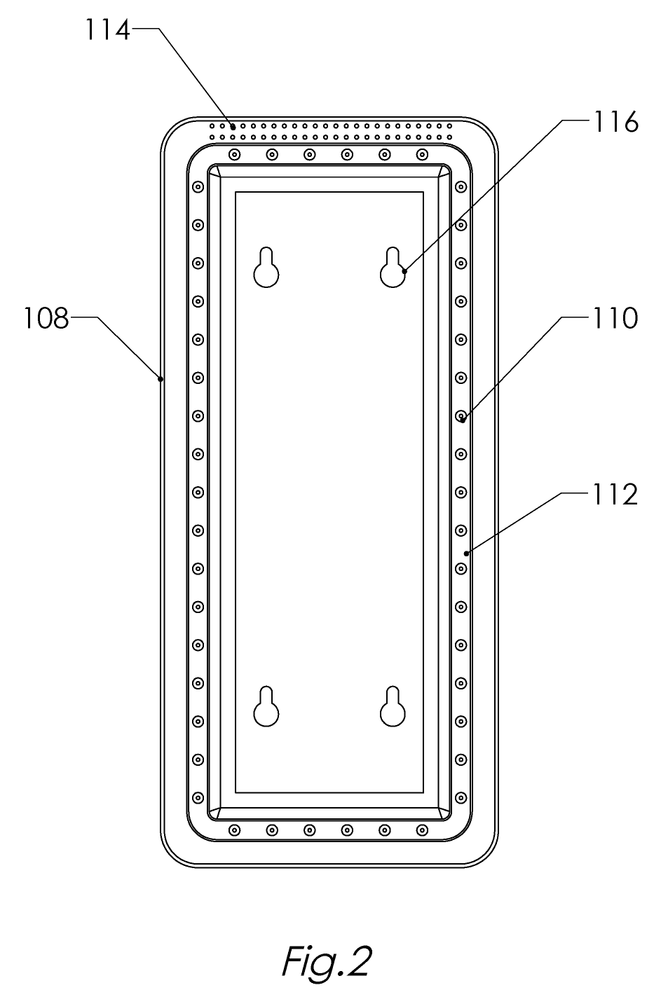

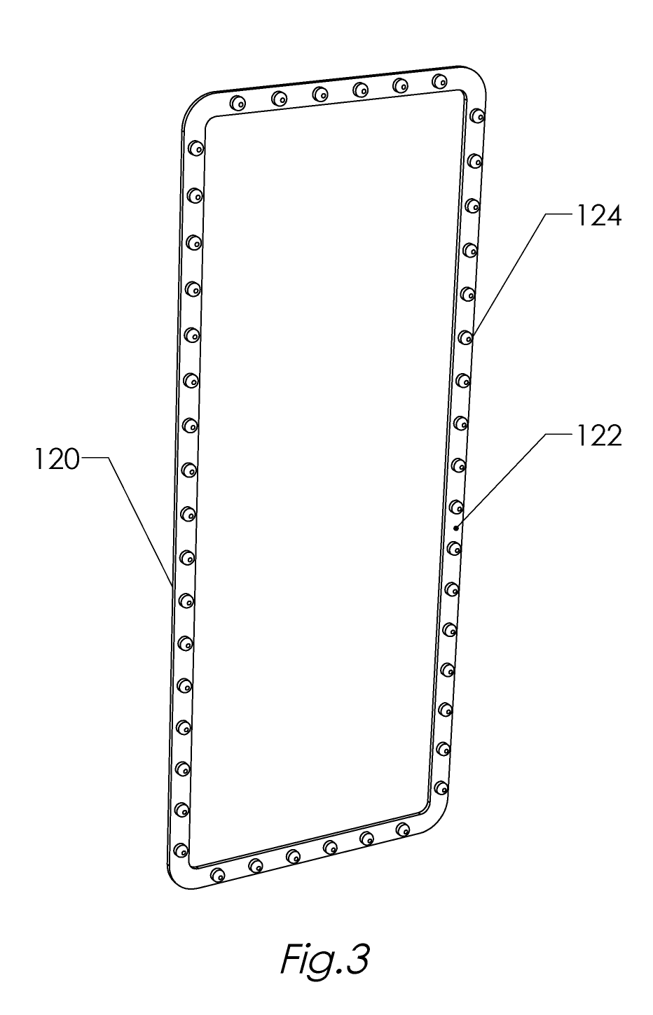

With reference to FIG. 2, an embodiment of the back panel 108 is illustrated. The back panel 108 may have a plurality of spaced-apart apertures 110 formed therethrough and disposed within a peripheral channel 112 thereof. The peripheral channel 112 may be sized and configured to closely receive a light source such as an LED array 120 (FIG. 3) as further disclosed below. The back panel 108 may include a plurality of apertures 114 formed therethrough to provide ambient air to the interior of the enclosure 100. The back panel 108 may also have a plurality of spaced-apart apertures 116 for positioning and securing the enclosure 100 to a wall with fasteners such as screws (not shown).

FIG. 3 illustrates an embodiment of the LED array 120. The LED array 120 may have a frame 122 sized and configured to be closely received in the peripheral channel 112 of the back panel 108. A plurality of LEDs 124 are disposed around the frame 122 such that when the frame 122 is received in the peripheral channel 112 of the back panel 108, the LEDs 124 align with the spaced-apart apertures 110 to thereby provide illumination to the interior and exterior of the enclosure 100.

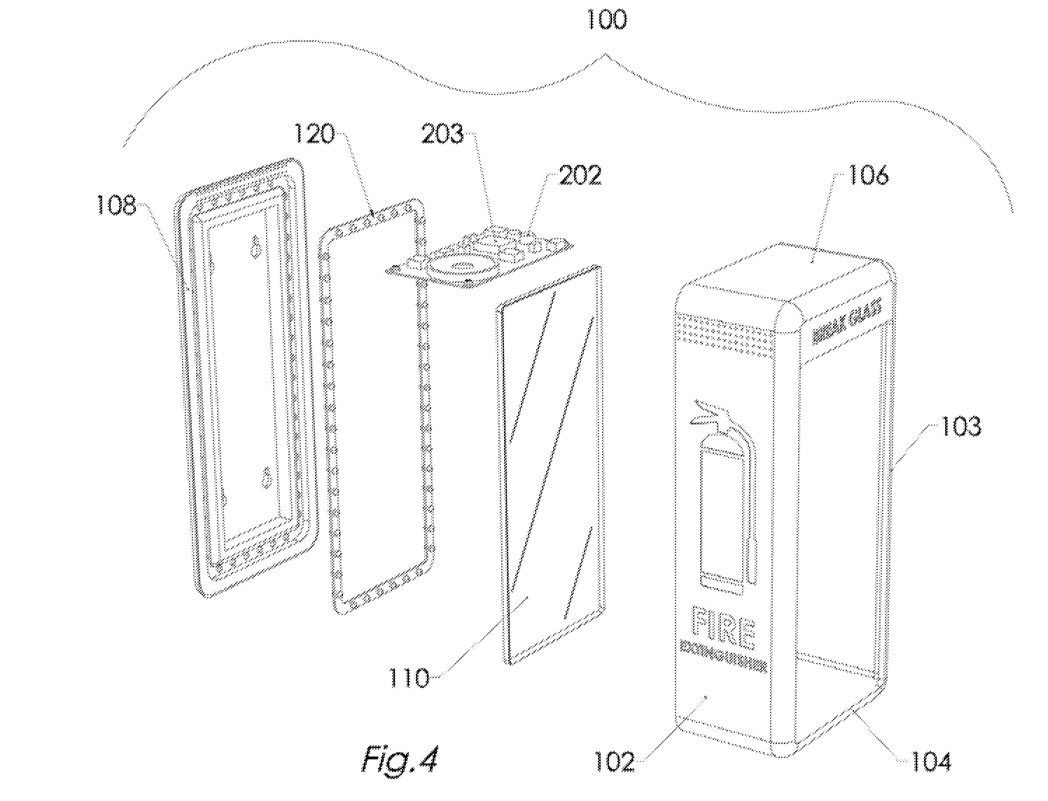

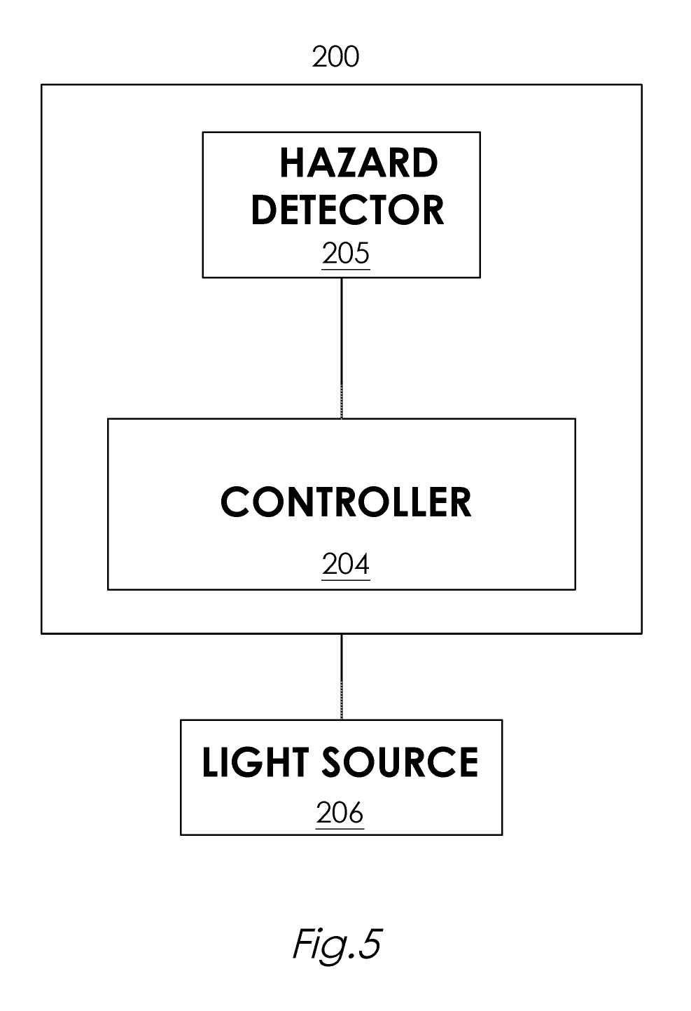

With reference to FIG. 4 and FIG. 5, a control system 200 is illustrated as embodied in components of a printed circuit board 202. A memory device may be enclosed in a fireproof enclosure 203. The printed circuit board 202 may be disposed under the top panel 106.

The control system 200 may have a controller 204 coupled to hazard detector 205 such as a smoke detector, heat detector and carbon monoxide detector, and to a light source 206 as illustrated in FIG. 5. The controller 204 may implement a method having a step in which a signal is received indicating a hazardous condition in the ambient environment from the hazard detector 205 and in which current is provided from a power supply (not shown) to the light source 206 to thereby illuminate the interior and exterior of the enclosure 100.

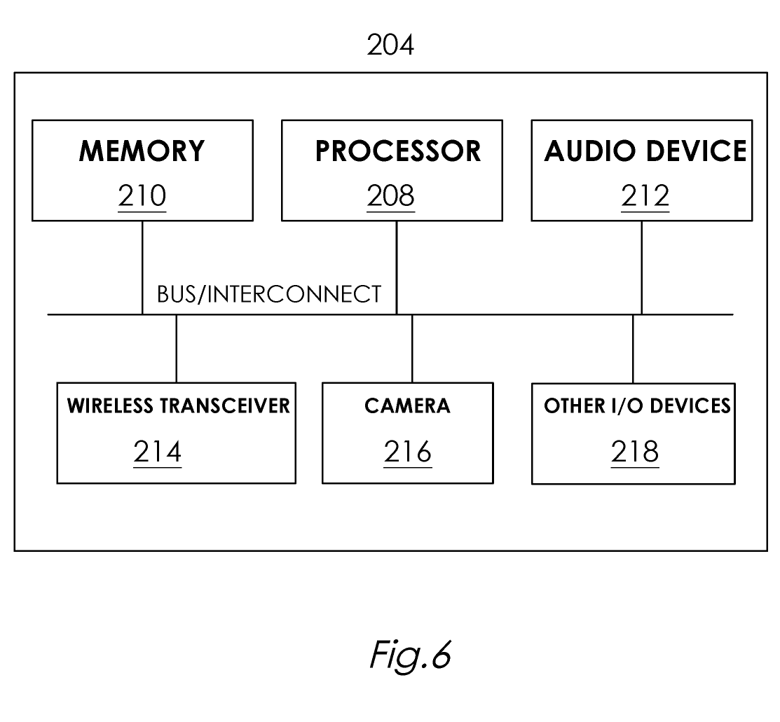

An embodiment of the controller 204 is illustrated in FIG. 6. The controller 204 may include a processor 208, a memory 210, an audio device 212, a wireless transceiver 214, a camera 216 and other I/O devices 218 coupled by means of a bus or interconnect. The processor 208 may include any type of logic circuit capable of executing instructions. The processor 208 is configured to execute instructions for performing the operations and methods discussed herein. The memory 210 may store information including sequences of executable program instructions that are executed by the processor 208 and digitized audio-video sequences captured by the camera 216. The memory may include a memory enclosed in the fireproof enclosure 203.

The audio device 212 may be operable to provide an audible signal indicating a hazard condition in the ambient environment.

The wireless transceiver 214 can be a WiFi transceiver, an infrared transceiver, a Bluetooth transceiver, a WiMax transceiver, a wireless cellular telephony transceiver, or other radio frequency transceivers. The controller 204 may be operable to send information including the existence of a hazard in the ambient environment, a realtime audio-video stream of the ambient environment, and the condition of the fire extinguisher to a remote receiver (not shown) by means of the wireless transceiver 214. The remote receiver may include a local control server, a remote Web application server, or a wireless electronic device such as a smartphone, smart watch, tablet or personal computer.

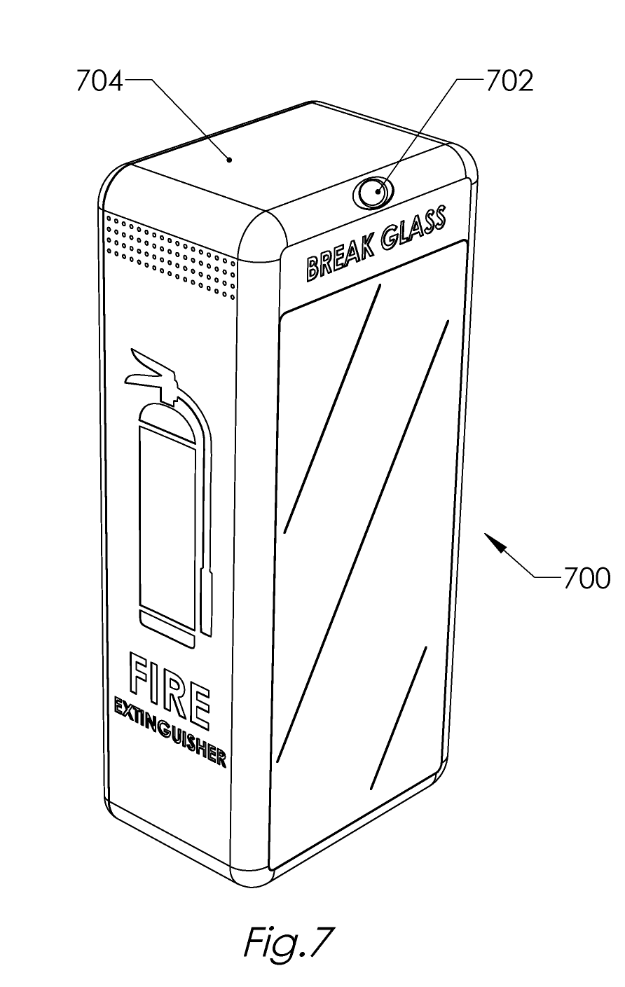

FIG. 7 illustrates an embodiment of a hazard detection and alarm enclosure 700. The enclosure 700 may include the features described above with reference to enclosure 100 and include a camera aperture 702 formed on a top panel 704 thereof. The camera aperture 702 may provide the camera 216 with a wide viewing angle of the ambient environment. The camera 216 may include an audio-video camera operable to capture audio-video sequences of the ambient environment. The captured audio-video sequences may be streamed to a remote receiver by the WiFi transceiver and stored in the memory enclosed in the fireproof enclosure 203 for subsequent retrieval.

It should be noted that the methods, systems, and devices discussed above are intended merely to be examples. It must be stressed that various embodiments may omit, substitute, or add various procedures or components as appropriate. For instance, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the shape, contour, positioning and arrangement of elements such as the panels and light source without departing from the spirit and scope of the invention. Further the light source can be disposed on the body of the enclosure by conventional means such as by the use of double stick tape, hardware screws, heat stake-ing and hook and loop features.

Having described several embodiments, it will be recognized by those of skill in the art that various modifications, alternative constructions, and equivalents may be used without departing from the spirit of the invention. For example, the light source may include an array having a different configuration and may be disposed in the body in an alternate manner. Accordingly, the above description should not be taken as limiting the scope of the invention.

I claim:

1. An enclosure comprising:
a body;
a light source disposed in the body; and
a control system coupled to the light source, the control system including a hazard detector and a controller, the controller operable to provide power to the light source upon receiving a signal from the hazard detector indicating a hazardous condition in the ambient environment.

2. The enclosure of claim 1, wherein the controller comprises a wireless transceiver operable to send information including the signal indicating the hazardous condition to a remote receiver.

3. The enclosure of claim 1, wherein the controller comprises an audio device and the controller is operable to provide power to the audio device upon receiving the signal indicating the hazardous condition.

4. The enclosure of claim 1, wherein the controller comprises a camera and a memory and the controller is operable to activate the camera upon receiving the signal indicating the hazardous condition and store audio-video sequences of the ambient environment in the memory.

5. The enclosure of claim 4, wherein the wireless transceiver is operable to send the audio-video sequences to a remote receiver.

6. The enclosure of claim 1, wherein the body includes a plurality of light transmissive panels.

7. The enclosure of claim 6, wherein one of the plurality of panels includes a graphical representation formed thereon.

8. The enclosure of claim 6, wherein the light source includes an LED array receivable in a peripheral channel formed in a back panel.

9. The enclosure of claim 6, wherein side panels and a back panel include a plurality of apertures formed therethrough to provide ambient air to an interior of the body.

10. An enclosure comprising:
a body including a plurality of panels;
an LED array disposed in a peripheral channel formed in a back panel; and
a control system coupled to the LED array, the control system including a hazard detector and a controller, the controller operable to provide power to the LED array upon receiving a signal from the hazard detector indicating a hazardous condition in the ambient environment.

11. The enclosure of claim 10, wherein the controller comprises a wireless transceiver operable to send information including the signal indicating the hazardous condition to a remote receiver.

12. The enclosure of claim 10, wherein the controller comprises an audio device and the controller is operable to provide power to the audio device upon receiving the signal indicating the hazardous condition.

13. The enclosure of claim 10, wherein side panels and a back panel include a plurality of apertures formed therethrough to provide ambient air to an interior of the body.

14. The enclosure of claim 10, wherein the controller comprises a camera and a memory and the controller is operable to activate the camera upon receiving the signal indicating the hazardous condition and store audio-video sequences of the ambient environment in the memory.

15. The enclosure of claim 14, wherein the controller comprises a wireless transceiver operable to send the audio-video sequences to a remote receiver.

16. An enclosure comprising:
a body including a plurality of light transmissive panels;
a light source disposed in the body;
a control system coupled to the light source, the control system including a hazard detector and a controller, the controller operable to provide power to the light source upon receiving a signal from the hazard detector indicating a hazardous condition in the ambient environment.

17. The enclosure of claim 16, wherein one of the plurality of panels includes a graphical representation formed thereon.

18. The enclosure of claim 16, wherein the controller comprises a wireless transceiver operable to send information including the signal indicating the hazardous condition to a remote receiver.

19. The enclosure of claim 16, wherein the controller comprises an audio device and the controller is operable to provide power to the audio device upon receiving the signal indicating the hazardous condition.

20. The enclosure of claim 16, wherein the controller comprises a camera, a wireless transceiver, and a memory, and the controller is operable to activate the camera upon receiving the signal indicating the hazardous condition and store audio-video sequences of the ambient environment in the memory and to send the audio-video sequences to a remote receiver by means of the wireless transceiver.
